(19) United States
(12) Patent Application Publication
(10) Pub. No.: US 2015/0168733 A1
(43) Pub. Date: Jun. 18, 2015

(54) LASER PROJECTOR SYSTEM WITH GRAPHICAL POINTER

(71) Applicant: THOMSON LICENSING, Issy de Moulineaux (FR)

(72) Inventors: Mark Francis Rumreich, Indianapolis, IN (US); James Edwin Hailey, Indianapolis, IN (US)

(73) Assignee: THOMSON LICENSING, Issy de Moulineaux (FR)

(21) Appl. No.: 14/389,403

(22) PCT Filed: Mar. 27, 2013
(86) PCT No.: PCT/US2013/034007

§ 371 Date: Sep. 30, 2014

Related U.S. Application Data
(60) Provisional application No. 61/617,758, filed on Mar. 30, 2012.

(51) Int. Cl. G02B 27/20; G02B 26/10

(52) U.S. Cl. CPC G02B 27/20; G02B 26/101; G02B 26/105; G02B 26/103

(57) ABSTRACT

A graphical laser pointer is provided that comprises: three laser sources, the laser sources generating light beams having different colors; and a means for scanning the light beams in a raster pattern.

### CROSS-REFERENCE TO RELATED APPLICATIONS

This application claims priority from U.S. Provisional Application 61/617,758 filed on Mar. 30, 2012 which is incorporated by reference herein in its entirety.

### FIELD OF THE INVENTION

The invention relates to laser pointers and methods for operating laser pointers.

### BACKGROUND

Pico-projectors are battery operated handheld projectors that can be used to display stored photos and video content or connected to external devices such as cameras and laptops. It is herein contemplated that pico-projectors could also be used as a graphical image laser pointer.

Miniature projectors such as pico-projectors, micro-projectors, nano-projectors or the like generally have the primary deficiency of being low light output devices. For a laser-based unit used as a stationary display, the typical display power is only 1 mW.

Maximum brightness can be increased by increasing the power of the output device. However, this increases the peak power requirement of the laser, thereby creating more safety issues, drawing more battery power and increasing heat dissipation.

To increase the peak brightness of the display, modulation of the scan velocity is disclosed. It is important to point out that a similar approach in CRT displays had been utilized in which the horizontal scan velocity was modulated; however, the horizontal scan velocity improved the apparent sharpness of edges, but was not used to increase brightness and was not thought of as increasing brightness in a CRT display.

However, one of the characteristics of laser projectors is the non-uniform scan pattern. This is a concession made to improve brightness at the expense of resolution.

Unfortunately, as graphical image laser pointers, pico-projectors have light output capabilities that are also insufficient. As such, a need exists to overcome this insufficiency.

### SUMMARY OF THE INVENTION

A graphical laser pointer is provided that comprises three laser sources for generating light beams having different colors and a means for scanning the light beams in a raster pattern. The means for scanning can include at least one scanning mirror that can oscillate or scan the beams. Alternatively, the means for scanning can be a fiber optic cable system having a servo steering system mechanism for scanning or oscillating the beams. The graphical laser pointer can be constructed such that a horizontal scan deflection limit and/or a vertical scan deflection limit can be dynamically varied.

In embodiments of the invention, the scanning means is adapted to scan the light beams according to a pattern from a first edge to an ending edge in the raster pattern to form a laser pointer image. The pattern can be a wave pattern of scan lines such that amplitudes oscillates along a first axis as the beams progressively scan along a second axis, wherein the second axis is substantially perpendicular to the first axis. The wave pattern can be a composite of a vertical scan profile and horizontal scan profile and the vertical scan profile can have a cyclic wobulation corresponding to the amplitudes. The cyclic wobulation can be a second harmonic of the horizontal scan profile. Such embodiments can implement variable scan velocity values in the second axis.

In other embodiments, the scanning means is adapted to scan a first pattern of scan lines of the light beams and a second pattern of scan lines of the light beams, wherein the raster pattern comprises the first and second patterns. The first pattern can be a wave pattern of scan lines such that amplitudes oscillate along a first axis as the beams progressively scan along a second axis that is substantially perpendicular to the first axis in which the first pattern has a first oscillation from a first edge of the raster pattern that is directed in a first direction along the first axis, and the scanning means is adapted to scan the light beams according to the first pattern from the first edge to a second edge of the raster pattern. The second pattern can be a wave pattern of scan lines such that amplitudes oscillate along the first axis as the beams progressively scan along the second axis. The second pattern can have a first oscillation from the second edge of the raster pattern that is directed in a second direction along the first axis in which the scanning means is adapted to scan the light beams according to the second pattern from the second edge to the first edge of the raster pattern. Such embodiments can implement variable scan velocity values in the second axis.

In additional embodiments, the means for scanning is configured to process image data to be n number of complete frames of video having m scan lines oriented along the first axis; the means for scanning is configured to have each complete frame comprise a first subframe and a second subframe; the means for scanning is configured to assign odd number rows of the m scan lines to the first subframe, wherein the first patterns correspond to the first subframe; and the means for scanning is configured to assign even number rows of the m scan lines to the second subframe, wherein the second patterns correspond to the second subframe. Such embodiments can implement variable scan velocity values in the horizontal axis.

Embodiments of the invention include a method of using a graphical image pointer that include displaying a first image on a screen from a first display device and displaying a second image on the screen such that the second image is from the graphical image pointer and has a plurality of colors. Here, the first image can be an image on a screen or wall having a generally fixed geometry and location and the second image can be a smaller image which can be smaller due to a collapsed raster scan or the like. These embodiment can include receiving image data of the second image to scan; generating light beams in the graphical image pointer responsive to the image data; forming a horizontal scan profile to direct the light beams in which the horizontal scan profile comprises cycles having oscillating amplitudes that are substantially parallel to a first axis and substantially perpendicular to a second axis; forming a cyclic wobulation responsive to the cycles; forming a vertical scan profile that includes the cyclic wobulation; and scanning the light beams according to a wave pattern that is a composite of the vertical scan profile and the horizontal scan profile to form the image such that the light beams are driven vertically parallel to the second axis from a first edge to an ending edge while oscillating horizontally parallel the first axis. Additional features can include generating a baseline vertical scan profile of motion along the second axis as a function of time; providing or selecting a cyclic wobulation profile of motion along the second axis versus time, wherein the cyclic wobulation profile comprises individual wobulation cycles in which one wobulation cycle corresponds to one half of a single wave of a wave pattern and another wobulation cycle corresponds to a second half of the single wave; and adding the cyclic wobulation profile to the baseline vertical scan profile to obtain the vertical scan profile. The cyclic wobulation profile can be a second harmonic of the horizontal scan profile. In these embodiments, the first display device can be a miniature display device such as a pico-projector and it can be operated according to one of the scanning methodologies described for the graphical image pointer in this application. Additionally, the graphical image pointer can be a light emitting diode system which does not operate as a laser in this pointer application. The graphical laser pointer in all embodiments can be adapted such that a horizontal scan deflection limit and/or a vertical scan deflection limit are dynamically varied. Further, the first display device and the graphical image pointer can be the same device having the same source color sources and raster scanning means.

Additional methods according to the invention can include receiving image data of the second image to scan; generating light beams in the graphical image pointer responsive to the image data; forming a horizontal scan profile to direct the light beams in which the horizontal scan profile comprises cycles having oscillating amplitudes that are substantially parallel to a first axis and substantially perpendicular to a second axis; scanning the light beams according to a wave pattern that is a composite of the vertical scan profile and the horizontal scan profile to form the image such that the light beams are driven vertically parallel to the second axis from a first edge to an ending edge while oscillating horizontally parallel the first axis in which variable scan velocity values are employed in the second axis.

Additional aspects of the invention can include receiving image data for images to scan; generating light beams responsive to the image data; scanning the light beams according to a first pattern from a first edge to an ending edge to form at least one image, the first pattern being a wave pattern of scan lines such that amplitudes oscillate along a first axis as the beams progressively scan along a second axis in which the second axis is substantially perpendicular to the first axis and the first pattern has a first oscillation from the first edge that is directed in a first direction along the first axis; and scanning the light beams according to a second pattern from a second edge to a second ending edge to form at least another image in which the second pattern is a wave pattern of scan lines such that amplitudes oscillate along the first axis as the beams progressively scan along the second axis. The second pattern can have a first oscillation from the second edge that is directed in a second direction along the first axis that is opposite the first direction. This aspect can include alternatingly scanning a plurality of the first and second patterns of the light beams and can include configuring or processing the image data to be n number of complete frames of video, wherein n is a whole number, the first patterns correspond to odd number frames of the n number of complete frames and the second patterns correspond to the even number frames of the n number of complete frames. In these embodiments and in others, variable scan velocity values can be employed in the second axis.

### BRIEF DESCRIPTION OF THE DRAWINGS

The invention will be explained in detail with reference to the drawings in which:

FIG. 1 shows views of a composite raster scan pattern and component vertical and horizontal scan patterns of the graphical laser pointer incorporated in the invention;

FIG. 2 shows views of raster scan patterns for a video image of the graphical laser pointer having a uniform brightness and a video image of the graphical laser pointer having non-uniform brightness;

FIG. 3 shows a block diagram of the system architecture according to the invention;

FIG. 4 shows a view of a serrated raster scan pattern versus a non-serated raster scan pattern;

FIG. 5 shows another view of a serrated raster scan pattern according to the invention;

FIG. 6 shows an additional view of a serrated raster scan pattern according to the invention;

FIG. 7 shows views of the raster scan patterns of interleaved scanning according to the invention;

FIG. 8 shows a view of another interleaving approach according to the invention; and

FIG. 9 shows a view of operating the graphical laser pointer system according to the invention.

### DETAILED DESCRIPTION OF THE EMBODIMENTS

A microprojector, nanoprojector or pico-projector or the like can be employed as a graphical laser pointer according to the invention; as such, the projector device when used as a graphical pointer can also suffer the same brightness deficiencies that conventional miniature projectors suffer when they are used as display devices.

With this in mind, an aspect of the disclosure is to provide a method of using a miniature projector as a graphical laser pointer in a system in which the following steps are also contemplated: displaying a first image on a screen from a first display device; and displaying a second image on the screen such that the second image is from a micro-projector or nano-projector or micro-projector laser pointer that has a plurality of colors. Here, the first display device can be a miniature projector device. Additionally, the first and second images can be produced from the same display device and the second image which is intended to be smaller than the first image can be produced during the vertical retrace of the first image. However, as suggested above, a miniature projector has insufficient power for use as a laser graphical pointer to create the second image. The invention can to some extent overcome this problem by reducing the scan to improve the brightness.

The miniature projector as a laser pointer is dynamic in the sense that the size and shape of the second image can change responsive to a user input. Brightness can be enhanced by collapsing the horizontal and vertical scans or incorporating other techniques which can include the utilization of a serrated scan rate, interleaving, or velocity modulation. Additionally, to improve display uniformity without reducing brightness, serrated and interleaved scanning are disclosed which can be incorporated into the use of a miniature projector as a first image device and/or a miniature projector as a laser pointer. It is important to point out that a similar approach (i.e. wobulation) has been used in the past to improve the vertical resolution in digital light projectors, but was not used to improve brightness uniformity.

An important consideration in laser miniature projectors is that unlike in CRTs in which the horizontal retrace interval is blanked, thereby providing a uniform horizontal scan pattern, the blanking horizontal retrace is not practical for laser projectors, because it would reduce the effective display brightness by half. This is due to the fact that the retrace time for laser projectors is equal to the active scan time.

In laser-based projectors used as the first and/or second image makers, a moving micromirror or micromirrors can be used to raster scan the laser beams in a manner analogous to the method used in CRTs. The horizontal scan motion is created by running the horizontal axis at its resonant frequency, which is typically about 18 KHz. In one of the presently preferred embodiments, the horizontal scan velocity varies sinusoidally with position. The scan controller uses feedback from sensors on the scanner to keep the system on resonance and at fixed scan amplitude. The image is drawn in both directions as the scanner sweeps the beam back and forth. This helps the system efficiency in two ways. First, by running on resonance, the power required to drive the scan mirror is minimized. Second, bi-directional video maximizes the laser use efficiency by minimizing the video blanking interval. This results in a brighter projector for any given laser output power.

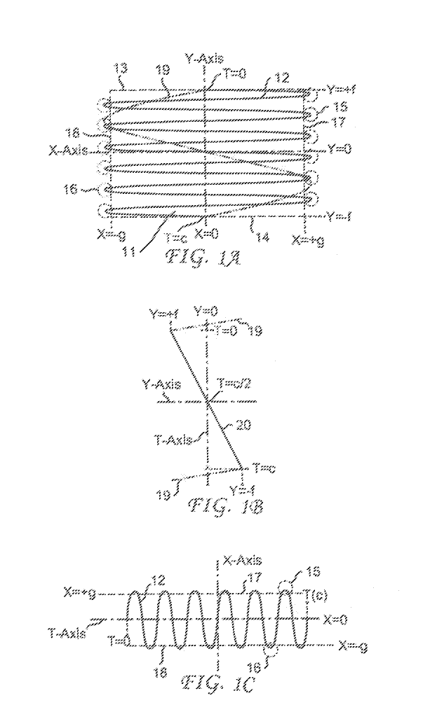

The vertical scan direction is traditionally driven with a standard sawtooth waveform to provide constant velocity from the top to the bottom of the image and a rapid retrace back to the top to begin a new frame as shown in FIG. 1. The frame rate is typically 60 Hz for an 848×480 WVGA resolution; the scan can be increased when the projector is used in lower resolution applications (e.g., in a system where particular frames of video are to be flashed or scanned multiple times). Views of a general raster scan pattern utilized by the invention are shown in FIG. 1. Specifically, FIG. 1A shows how the beams of light 12 of the projector are scanned by the mirror (or mirror system) across a screen or wall 11. In the particular example, FIG. 1A shows that the result of the mirror rotating horizontally across the X-axis and vertically along the Y-axis as a function of time in which T=0 can be a time in which the light 12 is first projected on the screen 11. Time T=0 can correspond to the top 13 of the screen as shown in FIG. 1A and T=0 can begin at horizontal level Y=+f. T=c can correspond to the bottom 14 of the viewable screen and T=c can be at horizontal level Y=−f. FIG. 1A further shows that the mirror raster scans the beams 12 sinusoidally downward from Y=+f at T=0 to Y=−f at T=c which effectively completes an image of video for one frame or subframe of video data. The number of individual scans to the right and left of the beams can vary depending on the system requirements and/or characteristic such as the designed resolution and the number pixels for the display. Each individual full scan cycle can include an overscanned right blanking region 15 at the far right of the scan as the beam reaches the vertical right edge 17 of the screen at vertical position X=+g and an overscanned left blanking region 16 at the far left of the scan as the beam reaches the vertical left edge 18 of the screen at vertical position X=−g. The overscanned blanking regions are areas outside the viewable screen in which the beams are either not on or the beams are appropriately shielded. There can be overscanning at the bottom 14 and top 13 of the screen 11 in which the mirror is projected vertically to positions corresponding to beyond the viewable screen edges.

FIG. 1B shows the vertical component of the scan mirror and FIG. 1C shows the horizontal scan component 25 of the scan mirror. FIG. 1B shows how the mirror scans the beams downward from the top 13 of the screen at Y=+f at T=0 to the bottom Y=−f at T=c. In FIG. 1B, the vertical axis is the time axis and the horizontal axis is the Y-axis.

FIG. 1C shows how mirror oscillates the beams laterally right from center line X=0 at T=0 toward the right edge 17 and into the overscanned blanking region 15, then toward the left toward the left edge left 18, then toward the right edge 17, and so on until the beams reach center line X=0 at T=c. FIG. 1C also shows the overscanned blanking regions 16, 15, which are the projected positions beyond X=−g and X=+g to which the mirrors are directed at the extremes of the sinusoidal cycles.

With reference to FIG. 1B, it is important to point out that the slope of the vertical component is linear and is ideal if the intensity needed for a particular image frame of video is uniform through the frame. However, a key feature of the invention is the rate of the vertical component changes during a particular frame of video when the intensity needed for the particular frame is not uniform in that some areas require greater brightness than others. As such, technically when there is to be a brightness change from one lateral region to an adjacent lateral region, the second derivative of the Y position with respect to the time T will become non-zero and the slope of the Y position with respect to the time T will increase if brightness is to be reduced and will decrease if the brightness is to be decreased.

### Modulation

The invention can increase the peak brightness of the graphical image pointer by modulating the vertical scan velocity. More particularly, scan velocity modulation (SVM) to improve brightness is accomplished by forcing the laser beam to spend more time on the bright picture areas and less time on the dark picture areas.

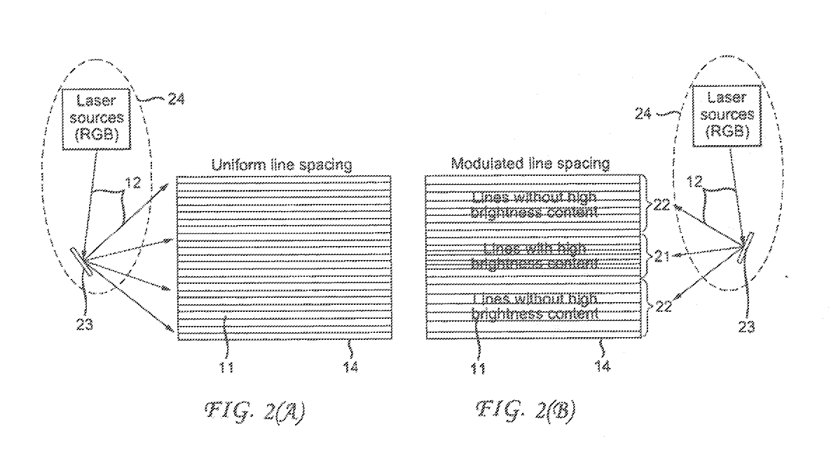

SVM can be performed horizontally and/or vertically. Because the horizontal scan is high frequency (for a mechanical device), it is very difficult to implement horizontal SVM. The proposed invention therefore has vertical SVM. What this means is that the horizontal line spacing is modulated, as shown in FIG. 2B as opposed to FIG. 2A. FIG. 2B exaggerates the effect to show the principle. In practice, the modulation is limited to prevent making the line structure visible and excessively degrading vertical detail where line spacing is increased.

The brightness of lines must be compensated in tandem with their spacing in order to maintain uniform contrast for the image. This means that the brightness must be increased for lines where the spacing is increased.

FIG. 2A shows an example expected scan line spacing of the color beams 12 of the laser pointer projector 24 as they are scanned when using the vertical scan rate shown in FIG. 1B. The vertical scan here has a constant slope 20 shown in FIG. 1B.

FIG. 2B in contrast shows how scan line spacing can be varied by intentionally varying the vertical scan velocity during different portion of a raster scan of the laser pointer projector if some enhancement is needed. In such a case, when greater brightness is required, the vertical rate component is slowed downed in regions which need greater brightness. When less brightness is required, the vertical rate component is increased. In this example, the middle lateral portion of the screen in FIG. 2B is a slow scan region 21 and this region is surrounded by two fast scan regions 22, thereby more efficiently supplying additional light to region 21 at the expense of regions 22.

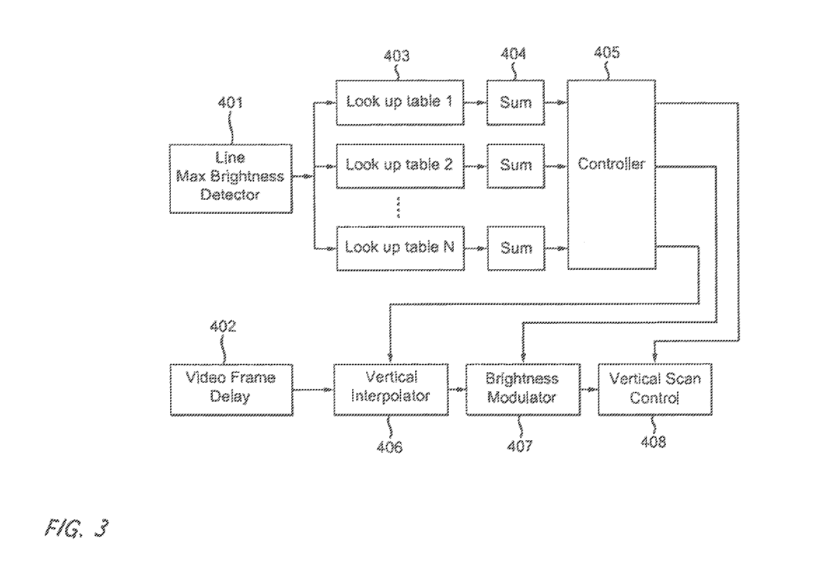

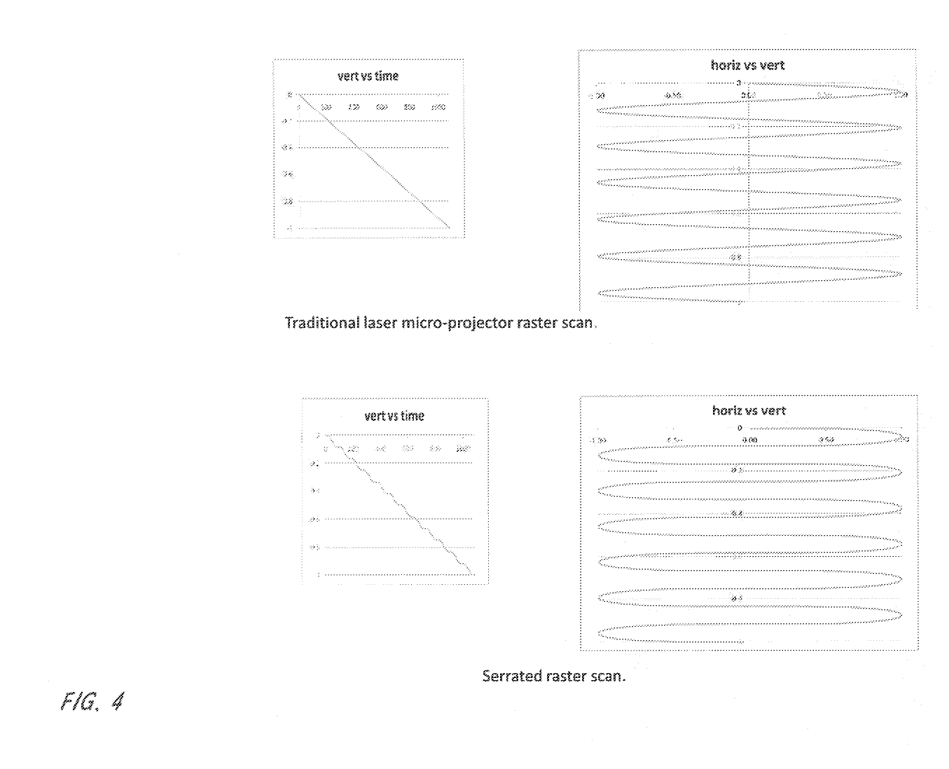

The FIG. 3 shows a block diagram of the system architecture for enhancing and more effectively obtaining desired peaked screen brightness. In this scheme which can be used for the graphical image pointer or the stationary first image device, a line brightness detector 401 is employed to determine the maximum brightness value for each line of video. Input video is analyzed in detector 401 to determine the level of brightness needed for an individual line of video. The detector can use filtering to prevent giving too much weight to a single bright pixel. Blocks 403 of the architecture in FIG. 4 provide a set of look-up-tables. The function of each table is to map line brightness values to values indicative of desired line spacing or alternatively, desired line frequency. Multiple tables are used to provide multiple display profiles. For example, the individual look-up tables could each correspond to a different level of maximum brightness enhancement for the controller 405 to select. As such, for a given video frame, the system or controller 405 can calculate the temporal characteristics (such as total vertical scan time) and/or spacing characteristics (e.g. the collective scan line spacings) for scanning the image for the given frame associated with employing the specific look-up tables. The line spacing values associated with the implementation of each look-up table can be summed in sum block 404 to produce a frame total value for each display profile associated with each look-up table for the given frame. This summation in sum block 404 can effectively be the total vertical scan time needed to implement the parameters of the given look-up tables. The controller 405 can locate the frame total for the look-up table that most closely matches the target total or better matches the target total than at least another look-up table. This can mean that the controller 405 selects the look-up table of the available look-up tables that will produce the highest picture brightness (or produce a higher picture brightness than some other look-up table outputs) and yet allow all of the sweeps of the light beams to be completely scanned under the constraint of the fixed video frame rate. In other words, look-up tables that enhance brightness but require such changes in the vertical scan rates that cause too few or too many horizontal scans to occur and/or would require the fixed video frame rate to be reduced are not employed for that given frame. The controller 405 then implements the corresponding display profile in order to control the vertical interpolator 406 to properly place individual pixel positions on the screen.

With regards to the interpolator 406, it is important to point out that the scan lines or sweeps of the light beams are not fixed with respect to pixels for all frames on the screen for this invention. This is different than known projector systems in which the particular scan lines are dedicated to the same particular pixels on a viewing surface for all frames. Rather, in this invention, the light beam outputs are uniquely synchronized for different frames with the vertical and horizontal positioning of the mirror or scanning means such that the appropriate level of light in terms of chromaticity and luminosity are projected on the correct pixel locations on the screen as the light beams are scanned for a particular frame, wherein the physical locations and spacings of the specific scan lines vary from frame to frame and the pixels that the specific scan lines are intended to illuminate vary from frame to frame. For example, in one implementation of the invention, for one frame the fifth complete horizontal scan of the light beams can provide the needed light for 1st, 2nd, and 3rd pixels in the 8th row of screen pixels and for another frame the fifth complete horizontal scan of the light beams can provide the needed light for 1st, 2nd, and 3rd pixels in the 6th row of screen pixels.

Anyway, the controller 405 provides inputs to modulate the beams in the brightness modulator 407 and correspondingly drives the vertical scan control 408 to select the appropriate scan velocity modulation. The controller 405 and a video frame delay processor 402 are both used as inputs to the vertical interpolator 406. In order to keep the total number of display scan lines constant, scan lines that are displayed more closely together must be offset by scan lines that are displayed further apart. The video frame delay 402 can be employed to ensure that the controller 405 is given ample time to determine the best or better look-up table to employ and to determine the appropriate values or control signals to employ to the drive the system components for the given frame. Because the desired spacing per scan line is a nonlinear function of brightness, the look-up-tables can be used to determine the best balance of brightness enhancement.

The table below shows an example of a look-up-table representing a profile to double picture brightness.

| line max brightness | | | line spacing |
|---|---|---|---|
| (input) | brightness goal | laser max | (output) |
| 0 | 0 | 0 | 2.00 |
| 5 | 10 | 20 | 2.00 |
| 10 | 20 | 40 | 2.00 |
| 15 | 30 | 60 | 2.00 |
| 20 | 40 | 80 | 2.00 |
| 25 | 50 | 100 | 2.00 |
| 30 | 60 | 100 | 1.67 |
| 35 | 70 | 100 | 1.43 |
| 40 | 80 | 100 | 1.25 |
| 45 | 90 | 100 | 1.11 |
| 50 | 100 | 100 | 1.00 |
| 55 | 110 | 100 | 0.91 |
| 60 | 120 | 100 | 0.83 |
| 65 | 130 | 100 | 0.77 |
| 70 | 140 | 100 | 0.71 |
| 75 | 150 | 100 | 0.67 |
| 80 | 160 | 100 | 0.63 |
| 85 | 170 | 100 | 0.59 |
| 90 | 180 | 100 | 0.56 |
| 95 | 190 | 100 | 0.53 |
| 100 | 200 | 100 | 0.50 |

For a line with maximum brightness of 100, the line spacing would be 0.50 units, wherein 1.00 units is the line spacing dimension for uniform spacing of the horizontal scan lines. Thus, a spacing of 0.50 units doubles the effective brightness compared to known projector operating conditions. For lines with 25 or lower max brightness, the scan line spacing would be 2.00 and the laser intensity would need to quadruple to compensate for the combined double scan line height and double brightness goal. Depending on picture content, this profile may or may not provide a frame total that matches the target total. In cases where the frame total is insufficient, the picture brightness enhancement would need to be throttled back. In cases where the frame total is more than needed, the scan line spacing would be decreased proportionately across the frame. In either situation, look-up tables with profiles corresponding to these cases would be used to direct the controller. Note that in this example, the look-up table provides a scan line spacing output. In an alternative approach, the look-up table would provide a scan line frequency output.

Other look-up tables for example can provide an opportunity to effectively enhance the brightness by 1.25, 1.5, 3, or 4 times that for operating the system using the conventional non-variable scan rates. For example, other look-up tables could correspond to having 1.25 (brightness goal 125), 1.5 (brightness goal 150), 3 (brightness goal 300), and 4 (brightness goal 400) times enhancement and could have the scan line spacing minimum outputs at 0.80, 0.67, 0.33, and 0.25, respectively. For these other look-up tables, the brightness goal point where the scan line spacings begin to vary from 2.0 (output) can be at 60 as in the table above or could be at some other level and the specific values in between the largest scan line spacings and smallest scan line spacings can be scaled in a similar fashion as that in the table above. The one table shown above and the examples are merely illustrative of the concept of using the invention. Actual look-up tables can include more data and can incorporate different values.

In sum with regards to this feature of scan modulation, a miniature projector such as laser micro projector or light emitting diode micro projector is provided that improves brightness by employing scan velocity modulation of the mirror that scans the beams on the screen. To increase brightness, the laser beam or light spends more time on screen regions which are supposed to have higher brightness; consequently, the laser beam spends less time on screen regions which are supposed to be lower brightness regions. To keep the display height constant, scan lines which are more closely together are offset with scan lines displayed further apart. The system can have one mirror as shown in FIG. 2 or it can have a plurality of mirrors. Also, there can be a plurality of lasers each for a different primary color. Additionally, the disclosure can be characterized as a method of operating a miniature projector system having raster scanning mirror or mirrors: receiving an image having a predetermined target brightness for each region of the image to project; and raster scanning the image onto a screen with the mirror or mirrors such that the horizontal scan rate of the mirror is generally inversely proportional the target brightness for the regions.

Another characteristic of miniature projectors is the non-uniform scan pattern. This can often be the result of the concession made to improve brightness.

### Serration

The another feature of the disclosure is serrated scanning for the first and/or second images which can be used in conjunction with constant velocity scanning or variable scanning in order to improve display uniformity that can be compromised by the variable velocity scanning FIG. 4 compares a traditional scan (top) to a serrated scan (bottom). The serrated scan produces left and right sweeps that are closer to parallel than the traditional scan. This improves both brightness uniformity and resolution uniformity.

The serrated scan can be accomplished by adding a small amount of the second harmonic of the horizontal-line frequency to the vertical scan. This can be achieved via the vertical scan modulation signal or through a secondary high frequency transducer coupled to the micro mirror assembly. The video typically must be re-sampled to correspond to the serrated raster scan pattern.

The sensitivity to the amplitude of the second harmonic signal is small. This is advantageous because the frequency response of the vertical modulation device at this frequency may be highly variable.

In sum, the invention with serration can effectively causes the scan lines to be closer to horizontal.

It should be further pointed out that modulating scan velocity together with serrated scanning can increase brightness and yet maintain uniformity. In other words, the serrated scanning can correct for some of the distortions that may be created by employing the variable scanning rate methodology.

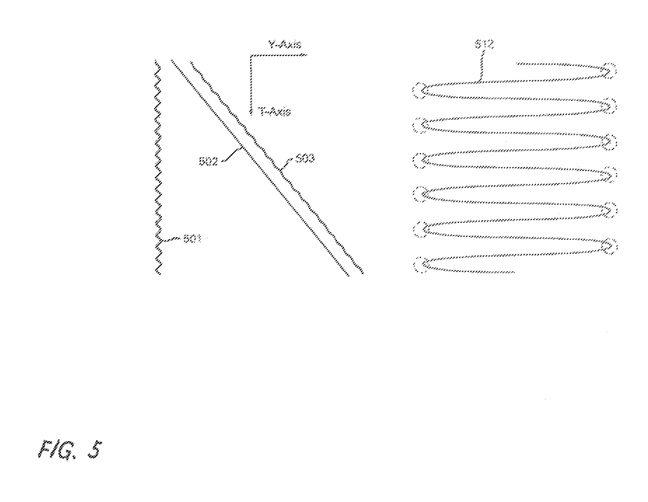

FIG. 5B shows a view of a serrated raster scan pattern 512 according to the invention in greater detail. FIG. 5B shows that a serrated scan can produce left and right sweeps that are closer to parallel than the left and right scan sweeps without serration such as the scan shown in FIG. 1A. This can improve both brightness uniformity and resolution uniformity. The serrated scan can be accomplished by adding a small amount of wobulation 501 to the baseline vertical scan profile 502. This wobulation 501 can be the second harmonic of the horizontal-line frequency or the second harmonic of the horizontal scan profile in FIG. 1C. As suggest above, this may be achieved via the vertical scan modulation signal or through a secondary high frequency transducer coupled to the micro mirror assembly. This wobulation 501, which can be sinusoidal as shown in FIG. 5A, can be added to the baseline vertical scan component 502, to produce the resultant serrated resultant vertical scan pattern 503. This serrated vertical scan component 503 when run with the horizontal scan component in FIG. 1C produces the serrated raster scan 512.

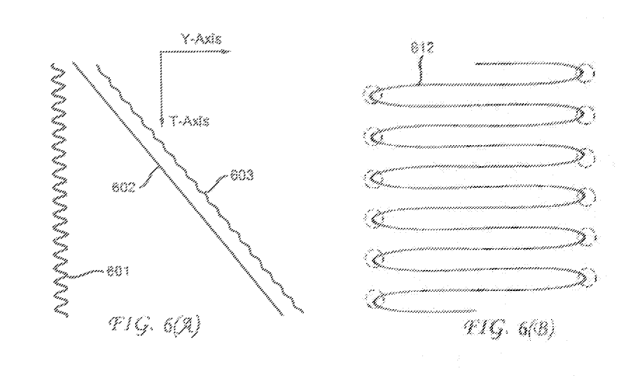

FIG. 6 shows addition example of serrated scanning in which the serration amplitude is changed by increasing the wobulation 601. This example again shows the use a second harmonic. The wobulation 601 is added to the baseline vertical scan component 602 to produce the resultant serrated vertical scan pattern 603. This serrated resultant vertical scan pattern 603 is then run with the horizontal scan component in FIG. 1C to produce the serrated raster scan 612. The circles at the extremes of scan 512 and 612 can be blanking regions.

### Interleaving

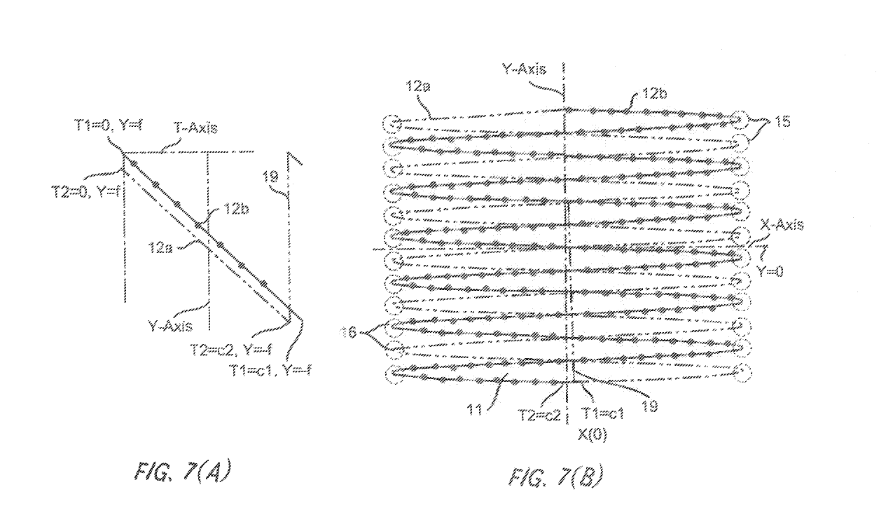

The additional feature of interleaved scanning can be incorporated into the first or second images, which can be used in conjunction with constant velocity scanning or variable scanning, in order to improve display uniformity that can be compromised by the variable velocity scanning. The interleaved scan is accomplished by a half-horizontal-line vertical shift on alternate display frames (shown with undotted lines on the raster patterns in FIG. 7(B)). This may be achieved via the vertical modulation signal (shown with undotted line in the vertical vs. time figure) or through a secondary “wobulation” type transducer coupled to the micro-mirror assembly. The video typical must be re-sampled to correspond to the interleaved raster scan pattern.

The advantage of interleaving is most pronounced at the left and right sides of the image. In the horizontal center of the screen, there is little or no benefit to interleaving.

Interleaved scanning which can be used alone or in conjunction with constant vertical velocity scanning or variable scanning in order to improve display uniformity that can be created by the variable velocity scanning. FIGS. 7A and 7B show an example of the interleaved scanning concept with constant vertical velocity scanning. FIG. 7A specifically shows the vertical scanning components for the two complete adjacent or back-to-back full screen scans of first beams 12a and second beams 12b that make up the interleaved pattern shown in FIG. 7B. FIG. 7B shows how the first scan of beams 12a begins at time T1=0, vertical position Y=+f. Beams 12a are scanned sinusoidally to oscillate horizontally as they are directed downward at the constant rate (or at their baseline rates) as shown in FIG. 7A to vertical position Y=−f at T1=c2. The scan of beams 12a begins by first directing the beams to the left and towards the overscan region (i.e. left blanking region 16) at the far left of the scan in a similar fashion as shown and described with respect to FIG. 1. FIG. 7B shows how the second scan of beams 12b begins at vertical position Y=+f at time T2=0, which is after T2=c1. The beams 12b for the second scan are scanned sinusoidally to oscillate horizontally as they are directed downward at the constant rate; however, here the scan begins by first being directed to the right and can be overscanned to a right blanking region 15 at the far right of the scan in a similar fashion as shown and described respect to FIG. 1. The interleaving then continues with alternation of scans of first and second beams 12a, 12b.

There are two ways for interleaving to be applied. The first is that one scan of first beam 12a represents a complete frame of video and the next scan of the next beam 12b represents a different complete frame of video in which each adjacent scan line within the given scan of the first beams 12a or the second beams 12b represent adjacent scan lines of video data. FIG. 7B basically shows this first scenario in that the scan of beams 12a is a first complete frame in which all possible pixels are scanned and each horizontal sweep is a scan line and the scan of beams 12b is a second complete frame in which all possible pixels are also likewise scanned.

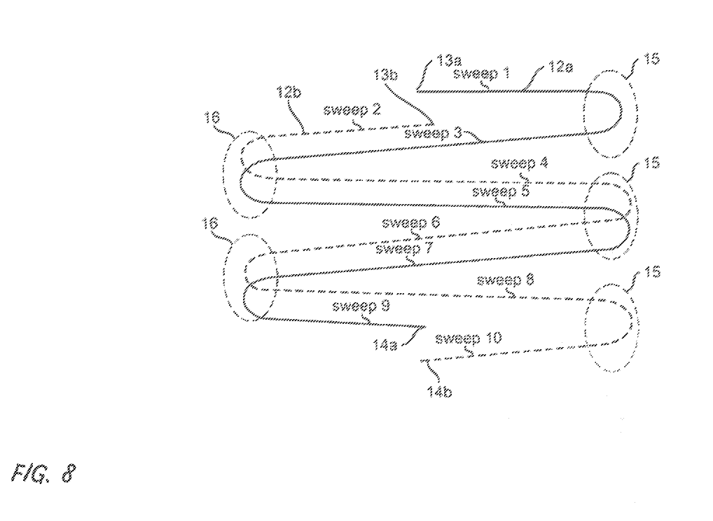

The second way for applying interleaving is that one scan of first beam 12a represents only half a frame of video and the next scan of the next beam 12b represent the second half of the frame of video in which adjacent scan lines within the scan of the first beams 12a itself or the second beams 12b itself represent two scan lines video data are spaced apart by a gap, wherein the gap is filled in by scan lines of video data from the scanning of the other half of the frame of video. A simplified view of this interleaving approach is shown in FIG. 8 which also shows the blanking regions 15, 16 on the left and right sides of the screen. More specifically, FIG. 8 shows that about half of the frame of video data is scanned first by beams 12a in which odd horizontal scan lines 1, 3, 5, 7, and 9 are produced in which the beams are scanned from a first top edge 13a to a first bottom edge 14a. Next, FIG. 8 shows that the other half of the frame of video data is scanned by beams 12b in which even horizontal scan lines 2, 4, 6, 8, and 10 are produced in which the beams are scanned from a second top edge 13b to a second bottom edge 14b. In other words, the interleaved scan of this type can be accomplished by a half horizontal scan line vertical shift on alternate display frames. Additionally, it is within the scope of the invention that the video data used for the scanning of the first and second beams could actually be different frames of video. When interleaving is applied, it is preferred for the video to be re-sampled to correspond to the interleaved raster scan pattern.

In sum, a feature of the invention can be characterized as a miniature projector that improves display/screen uniformity without reducing brightness by employing raster scan interleaving such that in one frame or subframe the raster scan begins in one direction and in the next frame or subframe the raster scan begins in the opposite direction. The method of operating the miniature projector could involve: receiving images to project; raster scanning a first image onto a screen with a mirror such that the odd number horizontal scan lines are scanned in one direction and even number scan lines are scanned in an opposite direction to the one direction; and raster scanning a second image onto a screen with the mirror such that the even number horizontal scan lines are scanned in the one direction and odd number scan lines are scanned in an opposite direction to the one direction. The two consecutive frames can actually be subframes, similar to that of pixel shifting.

In sum, the invention can be further characterized as a miniature laser projector and/or laser pointer that improves the respective display/screen uniformity without reducing brightness by employing raster scan intervening such that in one frame the raster scan begins in one direction and in the next frame the raster scan begins in the opposite direction. The method of operating the miniature projector system having raster scanning mirror could involve: receiving images to project; and raster scanning a first image onto a screen with the mirror such that the odd number horizontal scan lines are scanned in one direction and even number scan lines are scanned in an oppose direction to the one direction; and raster scanning a second image onto a screen with the mirror such that the even number horizontal scan lines are scanned in the one direction and odd number scan lines are scanned in an oppose direction to the one direction. The two consecutive frames can actually be subframes, similar to that of pixel shifting.

### Laser Pointing

The laser or LED based miniature projector for laser pointing can use three light or laser sources (RGB) to project a still or moving image on a wall or screen. These projectors as laser pointers provide greater utility than the standard laser pointers which are generally limited to projecting a single color dot, arrow or line, wherein patterns can be implemented by inserting a fixed diffractive optical element in the light path.

Using a miniature projector as a laser pointer in contrast to convention laser pointers allows an unlimited set of graphic-images to be used as the pointing element. Unlike traditional laser pointers, these images can be multiple colors, user defined, and time variant. They could even be video.

As mentioned above, the problem is brightness. Laser pointers require a much higher brightness than projectors because they are expected to overcome high ambient brightness levels.

As laser pointers, miniature projectors of this disclosure are similar to the conventional miniature projectors in that the images created are raster scanned by a moving micro-mirror as mentioned above.

When used as a laser pointer, the effective brightness can be increased by collapsing the horizontal and/or vertical scans to fractions of their normal values. For example, reducing the horizontal scan width by a factor of 16 and the vertical scan height by a factor of 9, the brightness would be increased by a factor of 144. However, even with this concentration, the effective brightness can still require enhancements with serrating, interleaving, or modulating scan velocities in order to have the second image (i.e., the smaller laser pointer image) stand out over the first image (i.e., the larger display image with generally constant screen location and size).

The trade-off is image size. Asymmetric scaling, as in the example, provides maximum brightness for a pointer graphical image bound by a square. Symmetric scaling is simpler, but results in a pointer graphical image bound by a rectangle.

Horizontal and vertical scans can be reduced by reducing the amplitude of the micro-mirror scanning signals. Alternately, an optical element can be used to modify the scan dimensions. A key feature of the disclosure is that as a laser pointer, the miniature projector can receive a video signal which can be dynamic video having moving images, changing colors, and/or changing intensities that can change from frame to frame or can be stationary still video, having fixed images. The video can be fed into the miniature projector from a computer, display device or the like and the user can hold or handle the projector by hand and point the images created by the projector on to any intended target.

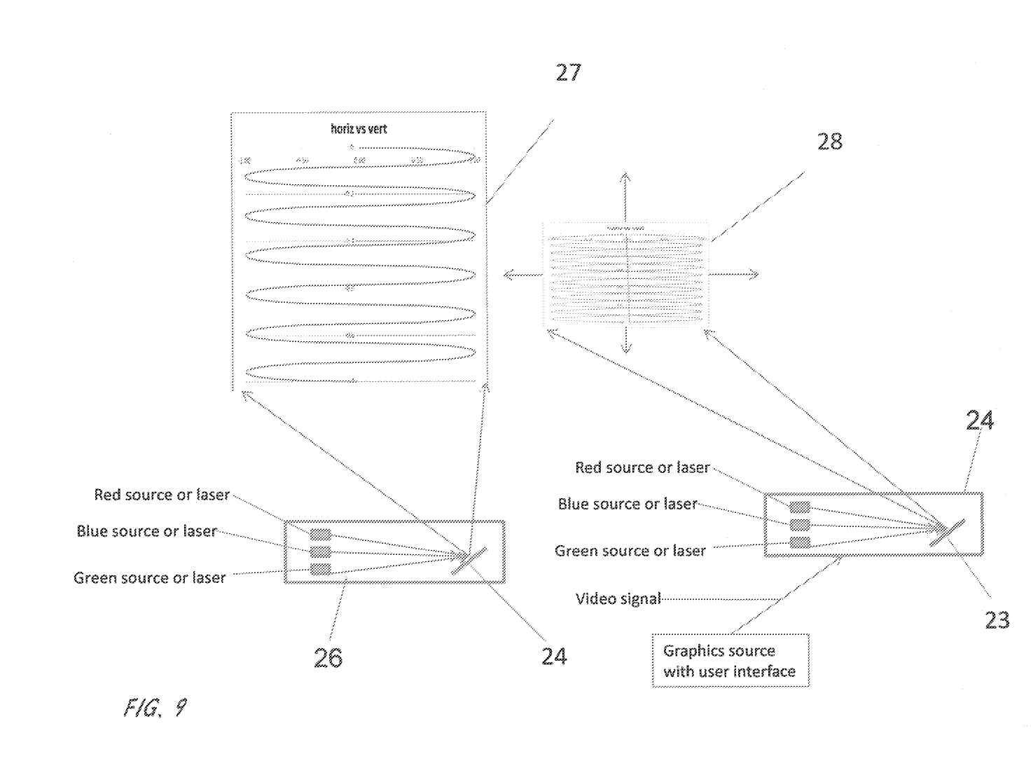

FIG. 9 shows one implementation in which a first image 27, which can occupy a stationary and fixed screen area, is created by a miniature laser or LED-based projector 26 using a serrated raster scan improvement mechanism and the second image 28, which is intended to be moveable (as signified by the 4 surrounding arrows) around the first image 27 and/or moveable inside the first image. Here, the graphical laser pointer 24 is using an interleaving raster scan. However, either of the images can incorporate either scan velocity modulation, interleaving, or serration.

It is intended that as a laser pointer, the miniature projector is adapted for holding by a hand so that it can easily be pointed by the user. As a laser pointer, the miniature projector can be part of a system that includes a user interface in which one or more users can select graphics, video, and still images to be displayed by the laser point. The laser pointer can be adapted to receive signals remotely from a device having a processor so that the user is not constrained in handling the laser pointer. In such case, the laser pointer can be wireless and can be operated by mouse.

In some embodiments which can use an interface such as a mouse for laser pointing, the first image and the second image (i.e. laser pointer image) can be produced by the same source and with the same deflection means. In such embodiments, the raster scan patterns shown in the figures can actually be the raster scan patterns for the first image, which can be an image on a screen or wall having a generally fixed geometry and location. The second image can be a smaller image within the perimeter of the first image. Here, the second image can be created during the vertical retrace 19 of the first image. For example, if the user wanted to show a graphical laser image (second image) near the center of the screen, during a the vertical retrace 19 in FIG. 1A near the X-axis (near Y=0), the appropriate horizontal deflection and source emissions could be employed to raster scan the second image as the sources are retraced vertically.

1. A graphical laser pointer comprising:
three laser sources, the laser sources generating light beams having different colors; and
a scanner to scan the light beams in a raster pattern.

2. The graphical laser pointer of claim 1, wherein the graphical laser pointer is adapted such that a horizontal scan deflection limit and a vertical scan deflection limit are variable.

3. The graphical laser pointer of claim 1, wherein the graphical laser pointer is adapted such that a horizontal scan deflection limit or a vertical scan deflection limit is variable.

4. The graphical laser pointer of claim 1, wherein the scanner is at least one of a scanning mirror or a fiber optic cable system having a servo steering system mechanism.

5. The graphical laser pointer of claim 1,
wherein the scanner is adapted to scan the light beams according to a pattern from a first edge to an ending edge in the raster pattern to form an image, the pattern being a wave pattern of scan lines such that amplitudes oscillate along a first axis as the beams progressively scan along a second axis, the second axis being perpendicular to the first axis, and
wherein the wave pattern is a composite of a vertical scan profile and horizontal scan profile and the vertical scan profile has a cyclic wobulation corresponding to the amplitudes.

6. The graphical laser pointer of claim 5, wherein the cyclic wobulation includes a second harmonic of the horizontal scan profile.

7. The graphical laser pointer of claim 1,
wherein the scanner is adapted to scan the light beams according to a pattern from a first edge to an ending edge in the raster pattern to form an image, the pattern being a wave pattern of scan lines such that amplitudes oscillates along a first axis as the beams progressively scan along a second axis, the second axis being perpendicular to the first axis, and
wherein the wave pattern is a composite of a vertical scan profile and horizontal scan profile and variable scan velocity values are employed in the second axis.

8. The graphical laser pointer of claim 1, comprising:
a first pattern of scan lines of the light beams; and
a second pattern of scan lines of the light beams, wherein the raster pattern comprises the first and second patterns;
wherein the first pattern is a wave pattern of scan lines such that amplitudes oscillate along a first axis as the beams progressively scan along a second axis that is perpendicular to the first axis, the first pattern has a first oscillation from a first edge of the raster pattern that is directed in a first direction along the first axis, wherein the scanner is adapted to scan the light beams according to the first pattern from the first edge to a second edge of the raster pattern; and
wherein the second pattern is a wave pattern of scan lines such that amplitudes oscillate along the first axis as the beams progressively scan along the second axis, the second pattern has a first oscillation from the second edge of the raster pattern that is directed in a second direction along the first axis, wherein the scanner is adapted to scan the light beams according to the second pattern from the second edge to the first edge of the raster pattern.

9. The graphical laser pointer of claim 1, wherein
the scanner is configured to process image data to be n number of complete frames of video having m scan lines oriented along the first axis;
the scanner is configured to have each complete frame comprise a first subframe and a second subframe;
the scanner is configured to assign odd number rows of the m scan lines to the first subframe, wherein the first patterns correspond to the first subframe; and
the scanner is configured to assign even number rows of the m scan lines to the second subframe, wherein the second patterns correspond to the second subframe.

10. The graphical laser pointer of claim 9, wherein variable scan velocity values are employed in the second axis.

11. A method of using a graphical image pointer comprising:
displaying a first image on a screen from a first display device; and
displaying a second image on the screen such that the second image is from the graphical image pointer and has a plurality of colors.

12. The method of claim 11, comprising:
receiving image data of the second image to scan;
generating light beams in the graphical image pointer responsive to the image data;
forming a horizontal scan profile to direct the light beams, the horizontal scan profile comprises cycles having oscillating amplitudes that are substantially parallel to a first axis and substantially perpendicular to a second axis;
forming a cyclic wobulation responsive to the cycles;
forming a vertical scan profile that includes the cyclic wobulation; and
scanning the light beams according to a wave pattern that is a composite of the vertical scan profile and the horizontal scan profile to form the image such that the light beams are driven vertically parallel to the second axis from a first edge to an ending edge while oscillating horizontally parallel the first axis.

13. The method of claim 12, wherein a variable scan velocity values are employed in the second axis.

14. The method of claim 12 comprising
generating a baseline vertical scan profile of motion along the second axis as a function of time;
providing or selecting a cyclic wobulation profile of motion along the second axis versus time, wherein the cyclic wobulation profile comprises individual wobulation cycles in which one wobulation cycle corresponds to one half of a single wave of a wave pattern and another wobulation cycle corresponds to a second half of the single wave; and
adding the cyclic wobulation profile to the baseline vertical scan profile to obtain the vertical scan profile; wherein the cyclic wobulation profile includes a second harmonic of the horizontal scan profile.

15. The method of claim 11, comprising:
receiving image data of the second image to scan;
generating light beams in the graphical image pointer responsive to the image data;
forming a horizontal scan profile to direct the light beams, the horizontal scan profile comprises cycles having oscillating amplitudes that are substantially parallel to a first axis and substantially perpendicular to a second axis;
scanning the light beams according to a wave pattern that is a composite of the vertical scan profile and the horizontal scan profile to form the image such that the light beams are driven vertically parallel to the second axis from a first edge to an ending edge while oscillating horizontally parallel the first axis; and
wherein variable scan velocity values are employed in the second axis.

16. The method of claim 11, comprising:
receiving image data for images to scan;
generating light beams responsive to the image data;
scanning the light beams according to a first pattern from a first edge to an ending edge to form at least one image, the first pattern being a wave pattern of scan lines such that amplitudes oscillate along a first axis as the beams progressively scan along a second axis, the second axis being substantially perpendicular to the first axis, wherein the first pattern has a first oscillation from the first edge that is directed in a first direction along the first axis; and
scanning the light beams according to a second pattern from a second edge to a second ending edge to form at least another image, the second pattern being a wave pattern of scan lines such that amplitudes oscillate along the first axis as the beams progressively scan along the second axis, wherein the second pattern has a first oscillation from the second edge that is directed in a second direction along the first axis that is opposite the first direction.

17. The method of claim 19 comprising:
alternatingly scanning a plurality of the first and second patterns of the light beams; and
configuring or processing the image data to be n number of complete frames of video, wherein n is a whole number, the first patterns correspond to odd number frames of the n number of complete frames and the second patterns correspond to the even number frames of the n number of complete frames.

18. The method of claim 11, wherein graphical laser pointer is adapted such that a horizontal scan deflection limit and a vertical scan deflection limit are adapted to vary.

19. The method of claim 11, wherein graphical laser pointer is adapted such that a horizontal scan deflection limit or a vertical scan deflection limit is adapted to vary.

20. The method of claim 11, wherein the first display device and the graphical image pointer are the same device and have the same source color sources and scanner.
